(19) United States
(12) Patent Application Publication
(10) Pub. No.: US 2019/0387694 A1
(43) Pub. Date: Dec. 26, 2019

(54) MODULAR PLANT PROTECTION

(71) Applicants: Bruno Rutman Pagnoncelli, Rio de Janeiro (BR); Pedro Rutman Pagnoncelli, Rio de Janeiro (BR)

(72) Inventors: Bruno Rutman Pagnoncelli, Rio de Janeiro (BR); Pedro Rutman Pagnoncelli, Rio de Janeiro (BR)

(21) Appl. No.: 16/450,855

(22) Filed: Jun. 24, 2019

Related U.S. Application Data
(60) Provisional application No. 62/688,953, filed on Jun. 22, 2018.

(51) Int. Cl. A01G 13/02; B64C 39/02

(52) U.S. Cl. CPC A01G 13/0281; B64C 39/024; B64C 2201/128; A01G 13/0287; B64C 2201/027; A01G 13/0237

(57) ABSTRACT

The present invention provides a modular apparatus for protecting a plant from invasive species and adapting a protective area as a plant grows with little to no post-planting maintenance. For example, a modular apparatus comprises a base comprising a first rim, a water storage, and a plug-in-joint, a lid comprising a second rim and an opening, wherein the first rim is configured to correspondingly fit the second rim, wherein the opening is configured to correspondingly fit the plug-in joint; and a recess disposed on an edge of the base and on an edge of the lid. An infinite number of modular apparatuses can be coupled to expand protection for plant growth. The modular plant protecting apparatus can be installed manually or deployed by an aerial vehicle into degraded areas with limited-access.

### CROSS-REFERENCE TO RELATED APPLICATION

The present application claims priority to U.S. Provisional Patent Application No. 62/688,953, filed Jun. 22, 2018 entitled “PLANT PROTECTING DEVICE AND METHOD,” the entire disclosure of which is incorporated by reference herein.

### FIELD OF INVENTION

This invention relates to plant protection from adverse environmental factors, and more specifically, to a modular apparatus that protects and accommodates plant growth to restore depleted forests and environments and reduce climate change effects.

### DESCRIPTION OF RELATED ART

Currently, over 2 billion hectares are available for forest and landscape restoration worldwide. Adverse climate change effects, including increased atmospheric carbon dioxide, can be potentially remedied with reforestation to reduce carbon dioxide emissions. Moreover, restoring riparian forests and mountain top forests are vital for sustaining rivers, watersheds, and other water resources. The benefits of forest growth include invaluable improvements in water quality and air quality.

Traditional approaches for reforesting remote areas with limited access are logistically complex, inefficient, and expensive. The primary challenges to reforestation include: the limited access due to mountainous relief; the presence of depleted soil; the possibility of long drought periods; the abundance of leaf-cutting ants, the growth of competing grasses and/or weeds, the angle of the terrain, and the need for long post-plant maintenance cycles. Current planting devices and methods require extensive human labor and time for installation and maintenance to plant seedlings and protect their growth. A skilled workforce is often required to plant each seedling in an area which can be dangerous to navigate on foot. Further, periodic post-plant maintenance visits slow down progress in reforestation. Traditional planting systems provide inadequate protection against small invasive species which hinder plant survival. Such prior systems are limited by the use of agrochemicals and insecticides to combat infestation, which contribute further to degrading the soil and water quality. Also, such prior art systems lack a means to expand protection to a growing plant as the plant grows beyond the area of protection provided by the system.

Tropical areas have lost resilience and often require human intervention to restore the tropical rainforest. Costs per hectare are high considering the need for a large skilled workforce to perform the laborious maintenance. Post-planting maintenance includes monitoring irrigation and controlling invasive species e.g., leafcutter ants and competing vegetation. Especially in degraded tropical biomes, invasive grass, leafcutter ants, and seasonal volatile rainfall post challenges to seedling growth. Further, a skilled workforce is often limited. Field workers can be exposed to adverse conditions including excessive ultraviolet rays, toxic agrochemicals, and hauling heavy equipment in hard-to-access or unstable terrain. Although agrochemicals help individual seedlings survive and grow, these toxic chemicals pollute the ecosystem and affect the wildlife.

The prior art provides some solutions for planting in environments that require human intervention. Commercial devices currently offer solutions for planting in desert landscapes (Groasis, The Netherlands; Land Life Company, The Netherlands), for saving water for arboriculture (Tal-ya, Israel), growing hydroponic systems in homes (Tower Garden, USA), for protecting and/or irrigating trees (Ooze Tube Tree, USA, Tubex, UK, T-PEE, USA, Dew Right, USA, Tree Mat, USA, Treebio, UK, Mr. Garden Rubber Mulch Tree Mat, USA), and for planting indoors (Floraflex, USA).

U.S. Pat. No. 8,752,330 to Hoff describes a plant aid for surrounding a young plant. The device includes a tube at least partly sideways surrounding a young plant. The plant aid also includes a water collection sheet for collecting atmospheric moisture. The water collection sheet has a water collection surface with a receiving surface, which receiving surface operatively makes a first angle with respect to gravity's orientation. The water collection sheet also has a collecting surface adjoining a lower edge of the receiving surface, which collecting surface operatively makes a second angle with respect to gravity's orientation. The first angle is smaller than the second angle.

International Patent Application Publication No. WO2011031153 to Hoff describes a removable plant protection system designed to provide shade or sun exposure to a soil area. The system comprises a wall module with an upwardly extending wall segment that is arranged for throwing a shadow on a soil area when the sun reaches its highest orbit point and for allowing a sun beam on the soil area at a time period on the day when the elevation of the sun is relatively low.

United States Patent Application Publication No. 2016/0128283 discloses an expandable tree protection device that covers an area surrounding a tree trunk and provides for expansion to accommodate growth of the tree trunk over time. This device, however, mentions no solution for controlling invasive species such as leafcutter ants which can greatly hinder seedling growth.

The prior devices fail to address issues of resource competition from invasive species such as leafcutter ants, mosquitos, insects, undesired vegetation, weeds, and grass. Further limitations include costly post-planting maintenance, use of toxic measures to manage invasive species, and the plant protection unsuitable for sloped terrains and adapting to varying planting area. Also, current devices can provide insufficient ventilation and insufficient water to a plant and be cumbersome to transport, in particular, to hard to reach areas.

Therefore, there is a need for a modular plant protection apparatus that requires minimal or no post-planting maintenance, uses non-toxic, passive measures against invasive species, and provides adaptable protection as a plant grows over time.

### SUMMARY OF THE INVENTION

The present invention overcomes these and other deficiencies of the prior art by providing a modular apparatus for protecting plant growth from invasive species and expanding a protection area with little to no post-planting maintenance. For example, a modular apparatus comprises a base comprising a first rim, a water storage, and a plug-in-joint, a lid comprising a second rim and an opening, wherein the first rim is configured to correspondingly fit the second rim, wherein the opening is configured to correspondingly fit the plug-in joint; and a recess disposed on an edge of the base and on an edge of the lid. An infinite number of modular apparatuses can be coupled to expand protection for plant growth. The modular plant protecting apparatus can be installed manually or deployed by an aerial vehicle into degraded areas with limited-access.

In one embodiment, a modular apparatus for protecting plant growth comprises a base comprising a first rim, a water storage, and a plug-in-joint, a lid comprising a second rim and an opening, wherein the first rim is configured to correspondingly fit the second rim, wherein the opening is configured to receive the plug-in-joint; and a recess disposed on an edge of the base and on an edge of the lid. In an embodiment, the base further is permanently or detachably coupled to the lid. In another embodiment, the apparatus comprises a capillary fabric. In other embodiments, the lid further comprises a textured surface comprising a peak and a valley and optionally an opening within a valley. In various embodiments, the base, the lid, or both comprise a circular form. In other embodiments, the base, the lid, or both comprise a rectangular form. In certain embodiments, the apparatus further comprises a guard. In certain embodiments, the apparatus comprises a material including polypropylene, an oxo-biodegradable material, a bagasse fiber, a bagasse-based fiber, a plant fiber, a plant-based fiber, or a combination thereof.

In another embodiment of the invention, a modular apparatus for protecting plant growth comprises: a base comprising a first inner rim, a first outer rim, a water storage, and a first plug-in-joint, a lid comprising a second inner rim, a second outer rim, and a second plug-in-joint, wherein the first inner rim is configured to correspondingly fit the second inner rim, the first outer rim is configured to correspondingly fit the second outer rim, and the first plug-in-joint is configured to receive the second plug-in-joint; and a recess disposed on the base corresponding to a recess disposed on the lid. In one embodiment, the lid further comprises a dual-colored material, wherein an exterior surface comprises a light reflecting color and an interior surface comprises a light absorbing color. In an embodiment, the base further is permanently or detachably coupled to the lid. In another embodiment, the apparatus further comprisse a capillary fabric. In multiple embodiments, the lid further comprises a textured surface comprising a peak and a valley and an opening within a valley. In an embodiment, the apparatus further comprises a guard. In specific embodiments, the apparatus comprises a material including polypropylene, an oxo-biodegradable material, a bagasse fiber, a bagasse-based fiber, a plant fiber, a plant-based fiber, or a combination thereof.

Some advantages of the invention include reducing costs associated with sustaining a manual workforce and reducing risk in planting in dangerous terrain. The invention enables reduced use of agrochemicals and insecticides which in turn improves the soil and water quality in the ecosystem. Traditional forest restoration approaches have expensive maintenance costs and inefficient irrigation and pest control. The invention allows for water storage on a sloped terrain. Also, the invention permits sufficient water entry while preventing the entry of invasive species such as leafcutter ants detrimental to plant growth. Another advantage of the invention includes passive microclimate control of a plant using a dual colored material that reflects and absorbs light.

The foregoing, and other features and advantages of the invention, will be apparent from the following, more particular description of the preferred embodiments of the invention, the accompanying drawings, and the claims. Other advantages and variants would be readily apparent to one skilled in the art and are within the scope of the invention.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 illustrates a perspective view of a modular plant protecting apparatus according to one embodiment of the invention;

FIG. 2 illustrates an exploded, perspective view of the modular plant protecting apparatus as shown in FIG. 1.

FIG. 3 illustrates an exploded, cross-sectional view of the modular plant protecting apparatus as shown in FIG. 1;

FIG. 4 illustrates a partial cross sectional, perspective view of a modular plant protecting apparatus revealing a capillary fabric according to one embodiment of the invention;

FIG. 5 illustrates a cross-sectional view of a modular plant protecting apparatus including a plant according to an embodiment of the invention;

FIG. 6 illustrates an exploded view of a modular plant protecting apparatus according to another embodiment of the invention;

FIG. 7 illustrates an exploded, cross-sectional view of the modular plant protecting apparatus as shown in FIG. 6.

FIG. 8 illustrates a top view and a cross-sectional view of a modular plant protecting apparatus according to another embodiment of the invention;

FIG. 9 illustrates a top view and a cross-sectional view of a modular plant protecting apparatus according to another embodiment of the invention;

FIG. 10 illustrates a perspective view of a modular plant protecting apparatus according to another embodiment of the invention;

FIG. 11 illustrates a cross-sectional view of the modular plant protecting apparatus as shown in FIG. 10;

FIG. 12 illustrates an exploded, perspective view of a modular plant protecting apparatus according to an embodiment of the invention;

FIG. 13 illustrates a perspective view of a modular plant protecting apparatus according to an embodiment of the invention;

FIG. 14 illustrates a cross-sectional view of the modular plant protecting apparatus including a plant according to an embodiment of the invention;

FIG. 15 illustrates a perspective view of a guard according to another embodiment of the invention;

FIG. 16 illustrates a planar view and a top view of a guard according to another embodiment of the invention;

FIG. 17 illustrates a perspective view of a modular plant protecting apparatus according to another embodiment of the invention;

FIG. 18 illustrates a perspective view of a modular plant protecting apparatus according to yet another embodiment of the invention;

FIG. 19 illustrates a cross-sectional view of the modular plant protecting apparatus as shown in FIG. 18;

FIG. 20 illustrates a top view of a modular plant protecting apparatus according to an embodiment of the invention;

FIG. 21 illustrates a top view of a modular plant protecting apparatus according to another embodiment of the invention;

FIG. 22 illustrates a top view of a modular plant protecting apparatus according to yet another embodiment of the invention;

FIG. 23 illustrates a top view of a modular plant protecting apparatus according to yet another embodiment of the invention;

FIG. 24 illustrates a perspective view of a modular plant protecting apparatus detachably coupled to an aerial vehicle according to an embodiment of the invention.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF PREFERRED EMBODIMENTS

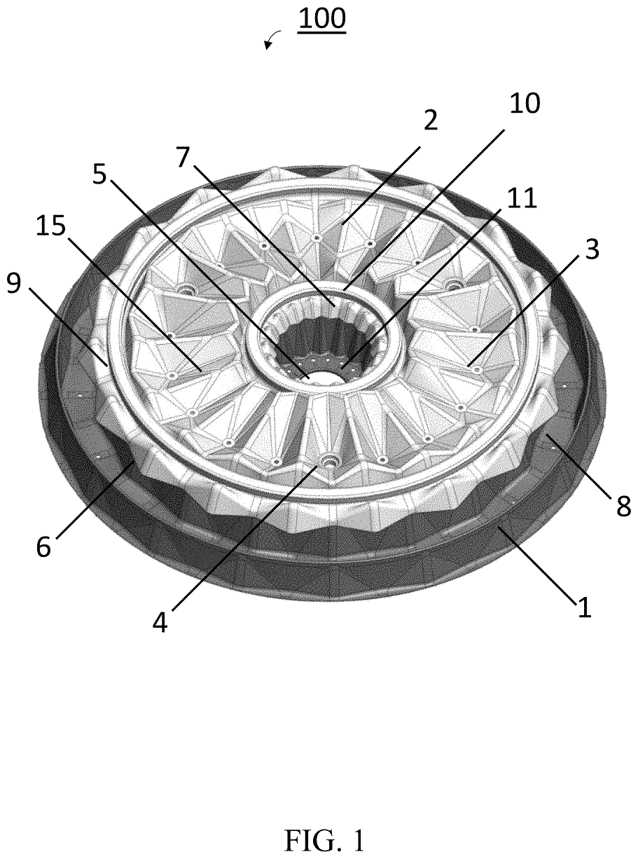

Preferred embodiments of the present invention and their advantages may be understood by referring to FIG. 1-24, wherein like reference numerals refer to like elements. The term “plant” refers to any type of photosynthetic organism suitable for planting but not limited to a seed, a seedling, a tree, a scrub, an herb, a vine, or any of a kingdom Plantae of multicellular eukaryotic. The term “invasive species” refers to any type of organism that competes for resources with a plant such as leafcutter ants, mosquitos, insects, pests, herbivores, any animal, weeds, grasses, and undesired growth.

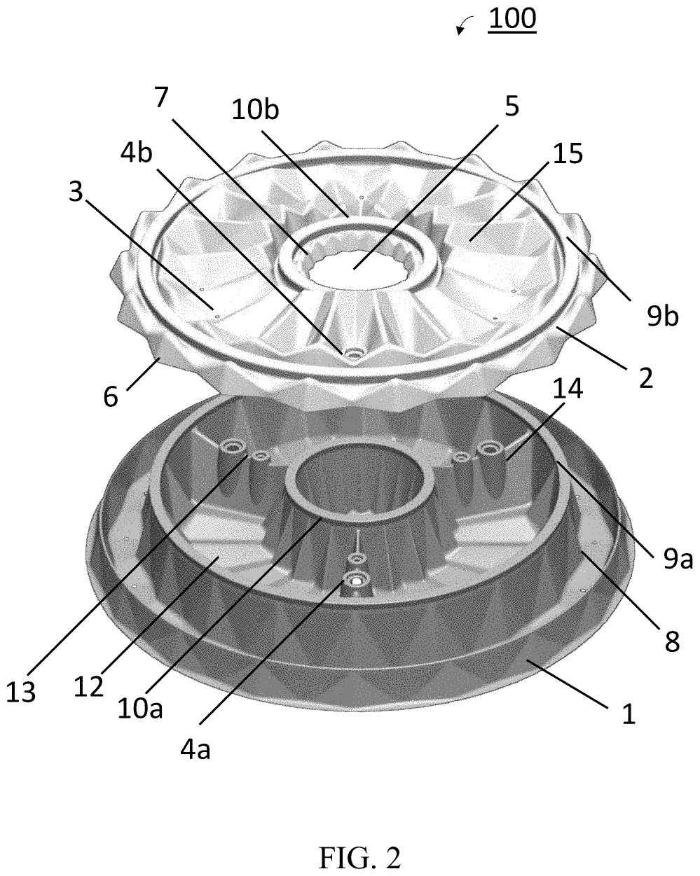

FIG. 1 shows a perspective view of a modular plant protecting apparatus 100. FIG. 2 shows an exploded, perspective view of the modular apparatus. As shown, the modular apparatus has a base 1 comprising a first outer rim, a first inner rim, a water storage 12, a first plug-in-joint 4a, a first external fitting 9a, and a first internal fitting 10a, a lid 2 comprising a second outer rim, a second inner rim, a second plug-in-joint 4b, a second external fitting 9b, and a second internal fitting 10b, and an opening 3, wherein the first outer rim is configured to correspondingly fit the second outer rim, the first inner rim is configured to correspondingly fit the second inner rim, the first plug-in-joint is configured to correspondingly fit the second plug-in-joint, first external fitting is configured to correspondingly fit the second external fitting, and the first internal fitting is configured to correspondingly fit the second internal fitting, and a recess 5 at the center of both the base and the lid. In other examples, the recess can be disposed on other locations on the base and on the lid.

In one example, the base and the lid form a donut-like shape with a centered recess in fluid communication with a plant. The diameter of the recess is between about 150 mm and about 300 mm, or another diameter smaller than 150 mm, larger than 300 mm without departing from the scope of the invention. In certain examples, the lid is detachably coupled to the base. In other examples, the lid can be integrally formed with the base.

The lid has a textured surface 15 to increase water capture and prevent the entry of invasive species. In certain examples, the textured surface has peaks and valleys to create more surfaces with which water vapor to contact. The base can also include a textured surface. The lid has a plurality of openings 3 strategically placed in the valleys or troughs of the textured surface to funnel water into the water storage of the base. Alternatively, the textured surface may have bumps, protrusions, or other textures that prevent leafcutter ants or other insects from entering the openings in the lid. The water storage collects water from rain or dew for passively plant watering. Specifically, the textured surface works as a water trap. When water vapor contacts a lid peak it condenses, water accumulates within a valley, and flows through the openings into the water storage.

The dimensions of the lid openings enable water entry yet slowed water evaporation from the water storage. Furthermore, the dimensions of the lid openings prevent entry of invasive species, such as leafcutter ants, mosquitos, and other insects. In one example, the lid openings comprise a diameter between about 5 mm and about 8 mm. The dimensions of the lid openings accommodate hydrogen bridging or hydrogen bonds between water molecules. In various examples, the lid openings have a round shape or non-round shape. Such lid openings can be identical or variable in dimensions.

As shown in FIG. 1, the lid has a circular form with a center opening and a textured surface preventing entry of invasive species. In this example, the textured surface includes at least one external negative shape 6 in connection with the lid's outer rim and at least one internal negative shape 7 in connection with the lid's inner rim. A negative shape refers to a structure comprising a slanted surface having a downward angle that meets another vertical surface having a vertical axis. Such external negative shape 6 and internal negative shape 7 have proved effective in preventing leafcutter ants crossing into the space 5 containing a plant. Leafcutter ants may climb the vertical surface but are unable to traverse the slanted surface. In other examples, the external negative shape, the internal negative shape, or both can another form that prevents the entry of invasive species into a space containing a plant. The base shape provides protection against excess sunlight, protects against unwanted growth near a plant, decreases water evaporation from the soil, and prevents nutrient loss or soil leaching.

The lid comprises an exterior surface and an interior surface. In certain examples, the exterior surface comprises a color that reflects light (heat) and the interior surface comprises a darker color than that of the exterior surface that absorbs light (heat). Such exterior and interior surfaces are made of selected materials having specific colors to help optimize microclimate parameters such as moisture retention and temperature and inhibit growth of competing species (e.g., weeds, vegetation, fungi, etc.) around a plant. For instance, an exterior surface made of an opaque and dark colored plastic prevents light transmission through the material and thereby prevents unwanted growth beneath the lid. The use of a dual color material enables passive control of the microclimate affecting plant growth. For use in cooler temperatures, both the exterior and interior surfaces of the lid can comprise an opaque, black plastic material to provide a warmer environment to a seedling.

In a preferred example, the lid is manufactured from a biodegradable plastic material that can be extruded in two layers. The two layers comprise a light-colored top layer and a darker-colored bottom layer, wherein the material comprises a thickness of about 1 mm. After extrusion, the lid may further be shaped by molding, die-cutting, or both.

The base couples to the lid using a combination of joints and fittings. This prevents the separation of the lid from the base especially in strong wind conditions. In particular, the first plug-in joint 4a of the base connects with the second plug-in joint 4b of the lid. In certain cases, the first plug-in joint is a male structure and the second plug-in joint is a female structure, or vice versa. Additionally, the plug-in joint 4 can receive a plant growth supporting material. Such material can be selected from a group including but not limited to: soil, fertilizer, plants that make green manure which helps fix soil nutrients, soil fixing agents, plant growing agents, or a combination thereof. The invention also provides a convenient means for adding material to the plant without having to disassemble the apparatus or displace it after installation. Further, the plug-in joints 4a and 4b are in fluid communication with the recess 5 to allow air circulation and gas exchange. Further, the first external fitting 9a and the first internal fitting 10a of the base connects, respectively, with the second external fitting 9b and the second internal fitting 10b of the lid. In certain cases, the first external fitting is a male structure and the second external fitting is a female structure, or vice versa. In other instances, the first internal fitting is a male structure and the second internal fitting is a female structure, or vice versa. Air can circulate above the base through the plug-in-joint, and external and internal fittings. This advantage in turn makes the soil within the recess area more fertile.

The base and the lid may be coupled detachably, semi-permanently, or permanently. The base may couple to the lid using one of the following including but not limited to: fasteners, snap-fit joints, adhesives, clips, or a combination thereof.

In certain instances, the base includes a filling space 8 for fixing the base to a ground surface. The filling space 8 accepts a weighted material such soil, sand, or rocks, to provide an inert mass on the base. The filling space 8 fixes the base to the ground using natural materials in the local environment without relying on materials imported into the environment such as stakes or screws. A filling space prevents the base from becoming displaced especially during strong winds.

The apparatus accommodates for a plant's natural growth pattern over time. Referring back to FIG. 1, the base may include a shield 11 that physically protects the soil and its constituent nutrients from adverse conditions while permitting a natural growth pattern. In particular, the shield is disposed within the recess. The shield comprises a thin material with perforations. As a plant's girth increases, the plant applies pressure against the shield causing it to tear at the perforations and enlarge area of the recess. In another example, the shield may comprise tabs made of a thin material concentrically arranged around the recess and the tabs fold upwards as a plant grows. The shield may be a detachable structure or an integrated structure with the base, the lid, or both.

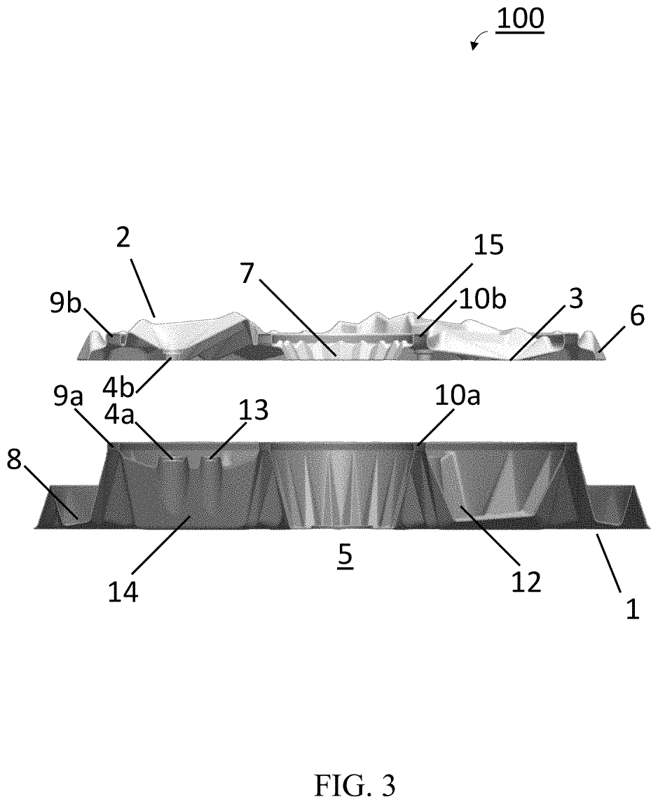

FIG. 3 shows an expanded cross-sectional view of the modular plant protecting apparatus 100. As shown in FIG. 2, the water storage 12 is partitioned by a rib 14. The rib 14 provides structural support upon which a capillary opening 13 is disposed. The ribs enable even distribution of water within the water storage, and in particular, sufficient watering of a plant growing on uneven and/or sloped terrain.

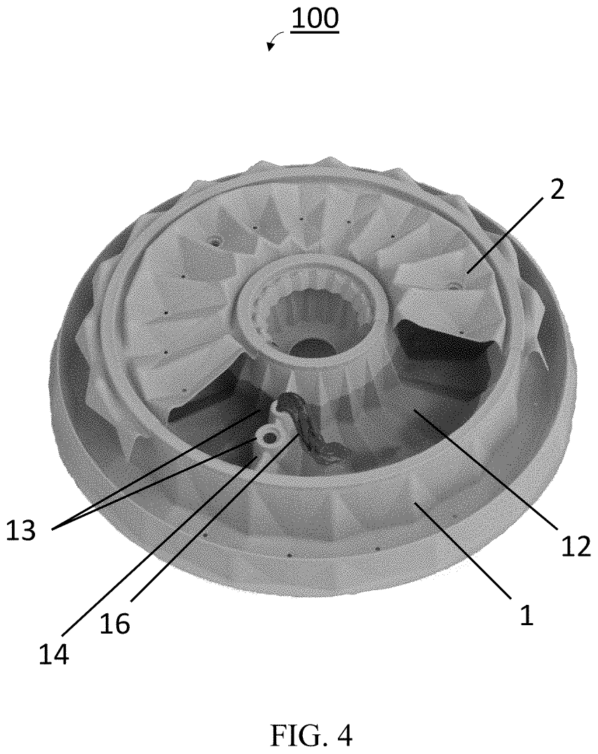

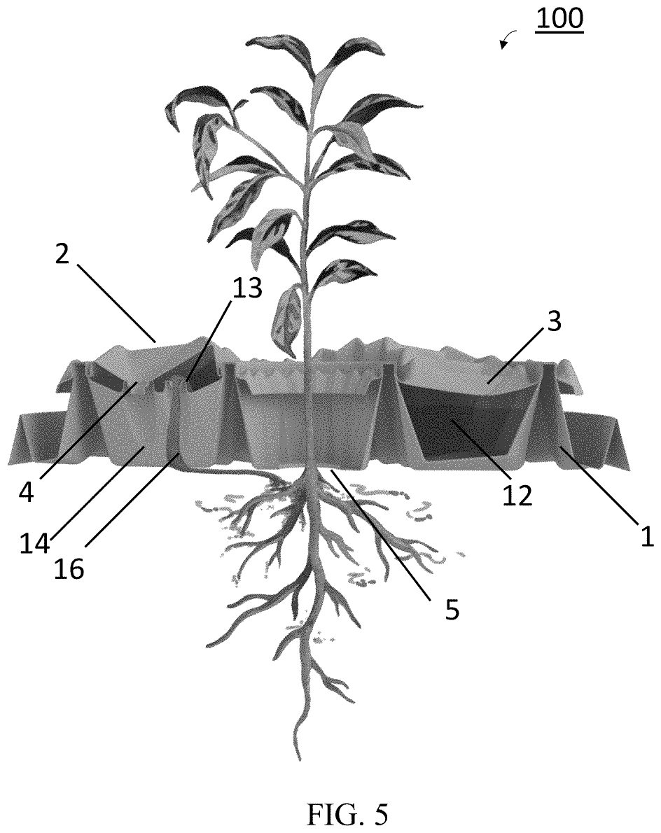

FIG. 4 shows a partial cross-sectional, perspective view of the modular plant protecting apparatus 100. FIG. 5 shows a cross-sectional view of the modular apparatus with a plant. On the base, the capillary opening 13 disposed on the rib 14 enable a capillary fabric 16 to transport water from the water storage to a plant root. In various examples, the capillary fabric is made of a water absorptive material, felt, capillary matting, matting, or a combination thereof. The ability for a plant to access water, especially during drought conditions, is a major advantage for post-plantation survival.

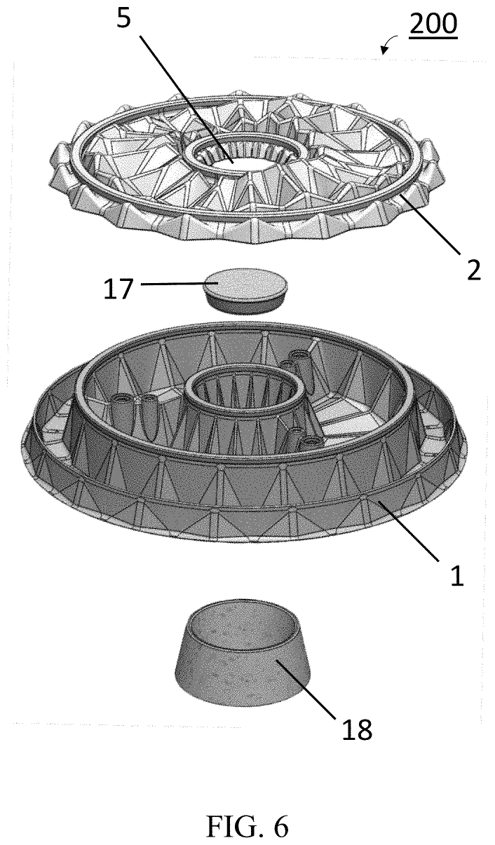

FIG. 6 shows an exploded view of a modular plant protecting apparatus 200. This example is similar to apparatus 100 with the addition of a capsule 17 that contains at least one plant supporting material. Such plant supporting material may include seeds and a substrate. An apparatus having a capsule 17 may be used in combination with a substrate 18. Here, the substrate forms a bowl shape that surrounds the capsule in the assembled apparatus. The substrate 18 includes plant growth promoting agents such as nutrients which slowly release into the soil over time to enhance low nutrient soil. Such plant growth promoting agents include, but are not limited to, nitrogen, phosphorous, calcium, or a combination thereof. In certain examples, the substrate 18 is placed in space 5 to provide nutrition to a plant growing in low nutrient soil. One advantage of the substrate is that it reduces the need for periodic post-planting maintenance. Further, the substrate may be compacted into a solid unit under high-pressure to form a smaller volume that is easier transport to hard-to-reach areas.

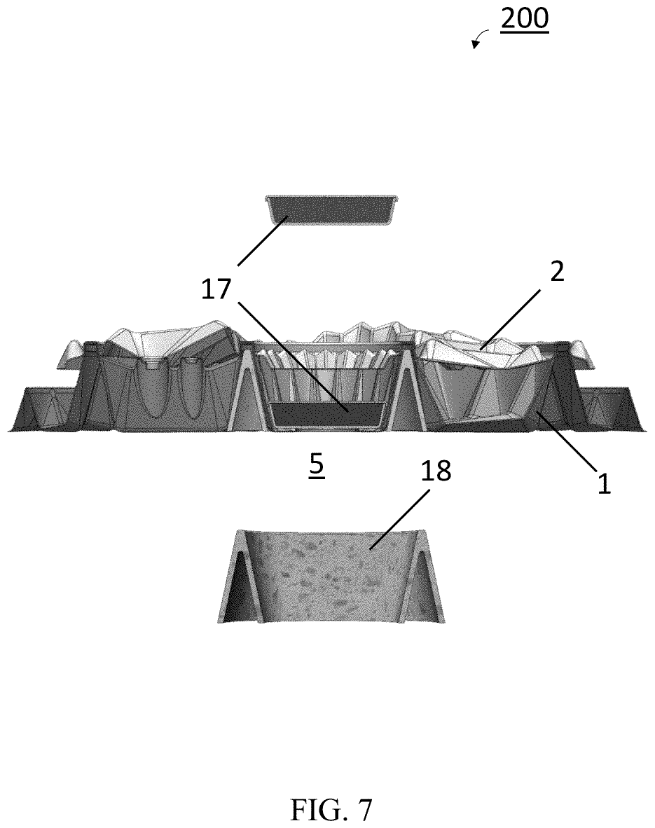

FIG. 7 shows an exploded, cross-sectional view of the modular plant protecting apparatus 200. In this example, the disc-shaped capsule contains plant material to be placed within the recess for germination. Additionally, the bowl-shaped substrate can be placed beneath the base. The capsule may comprise another non-disc shape. The substrate may comprise a non-bowl shape.

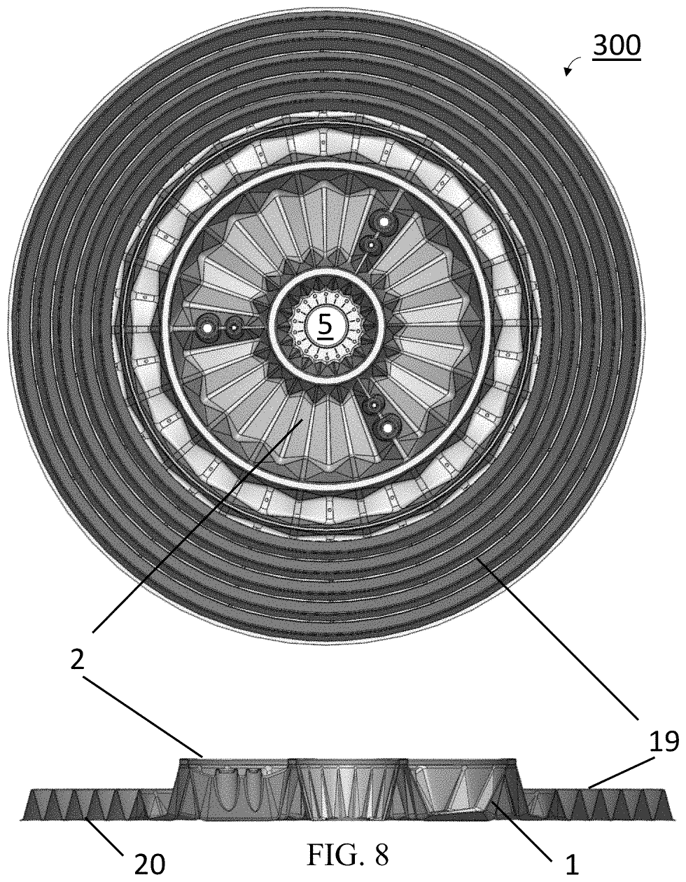

The invention provides solutions to accommodate plant growth beyond the protection of the apparatus. FIG. 8 shows a top view and cross-sectional view of a modular plant protecting apparatus 300. This apparatus includes a soil protecting structure 19 that extends plant protection beyond the area covered by the base and the lid. The soil protection structure has a textured surface and drainage holes 20. The soil protection structure is made of a biodegradable material that is a plastic or a fabric, or a combination thereof. The textured surface maximizes surface area for water collection, for shade coverage, and for a barrier from invasive species. The textured surface can include concentric ring groves and drainage holes between the concentric ring groves to facilitate passive watering to the soil beneath the soil protection structure. The soil protection structure can be extended radially by adding concentric ring groves to the initially implanted apparatus and thus expand the protection area provided by the apparatus.

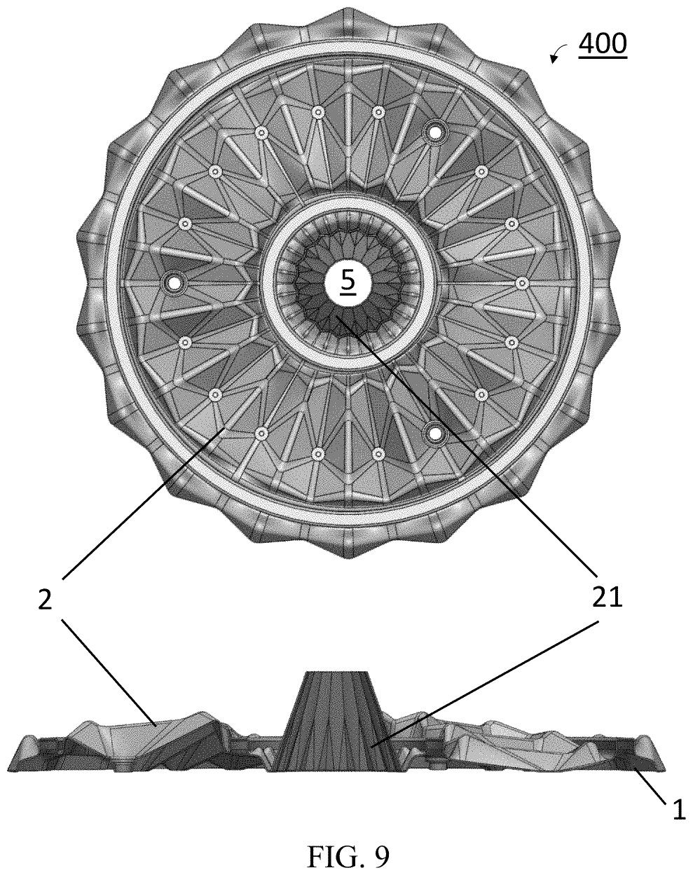

FIG. 9 shows a top view and cross-sectional view of a modular plant protecting apparatus 400 having a guard 21. This example has identical or similar features to the aforementioned apparatuses. As shown, the guard is a cone-like structure with open ends and a textured surface. The textured surface has peaks and valleys or other textures described above that prevent the entry of invasive species. Optionally the guard can have openings on the textured surfaces, in particular in the valleys, to enhance capture of dew for plant watering and prevent entry of leafcutter ants or other insects. The modular apparatus can include a negative shape 6 around the perimeter of the apparatus. The guard provides shade within the recess 5. Further, the guard protects a plant growing in height against adverse factors such as strong wind or invasive species. In other cases, the guard may comprise a non-conical form with a smooth surface. In certain examples, the guard comprises one or more units.

The base, the lid, or both may be manufactured as separate units or a single unit. In various examples, the base, the lid, or both can have a circular, rectangular, polygonal, or another shaped form. In multiple examples, the base and the lid are permanently coupled or detachably coupled.

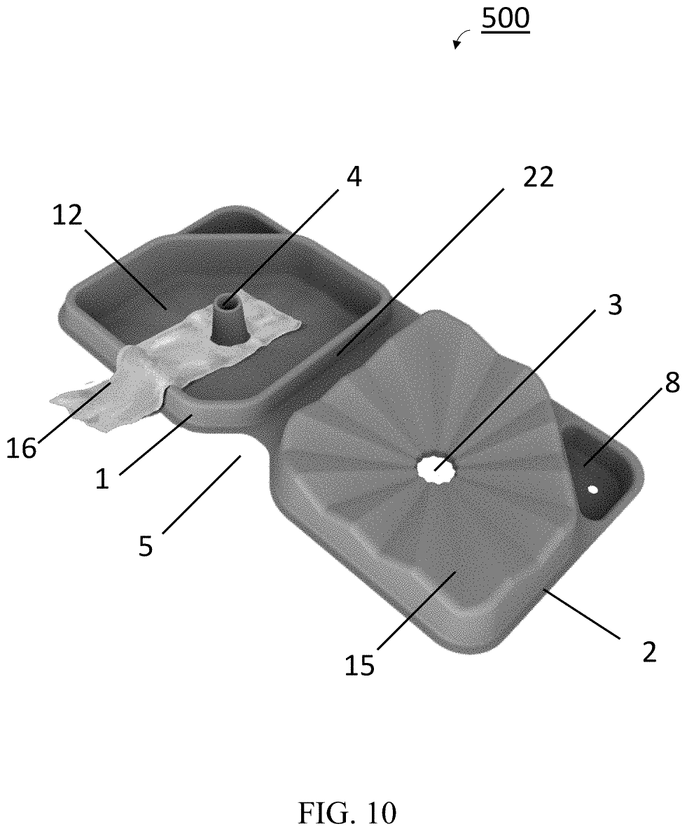

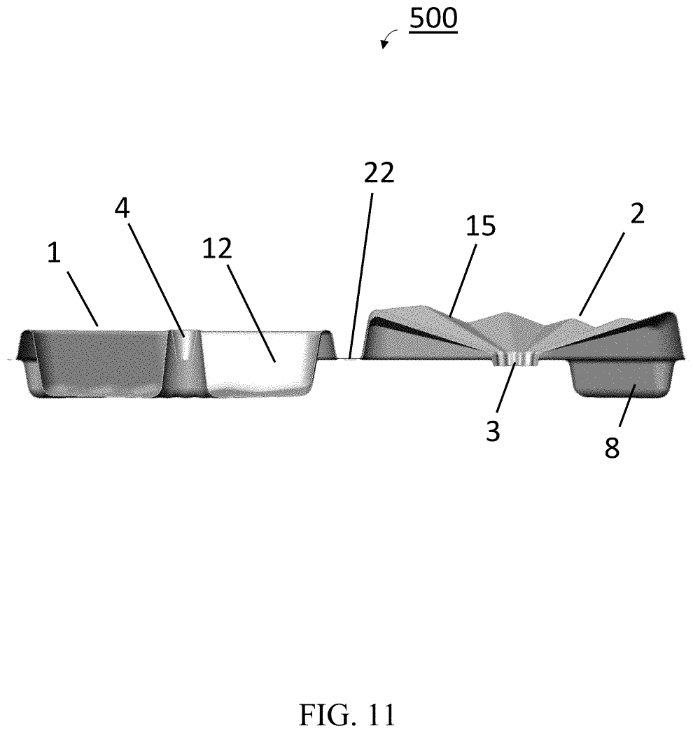

In various alternative examples, the apparatus comprises a base integrally coupled to a lid. As shown in FIG. 10, a modular plant protecting apparatus 500 comprises a base 1 connected to a lid 2 by a linkage 22. FIG. 11 illustrates a cross-sectional view of the modular apparatus. The modular apparatus comprises a base 1 comprising a first rim, a water storage 12, and a plug-in-joint 4, a lid 2 integrally coupled to the base comprising a second rim and an opening 3, wherein the first rim is configured to correspondingly fit the second rim, wherein the opening is configured to correspondingly fit the plug-in-joint; and a recess 5 disposed on an edge of the base and on an edge of the lid. The modular apparatus includes a rectangular structure. The base and the lid each include a filling space 8. The lid has a textured surface 15 with an opening 3 through which water enters a water storage of a base. A capillary fabric 16 disposed on the water storage and on the recess enables water transport from a water storage to a plant root.

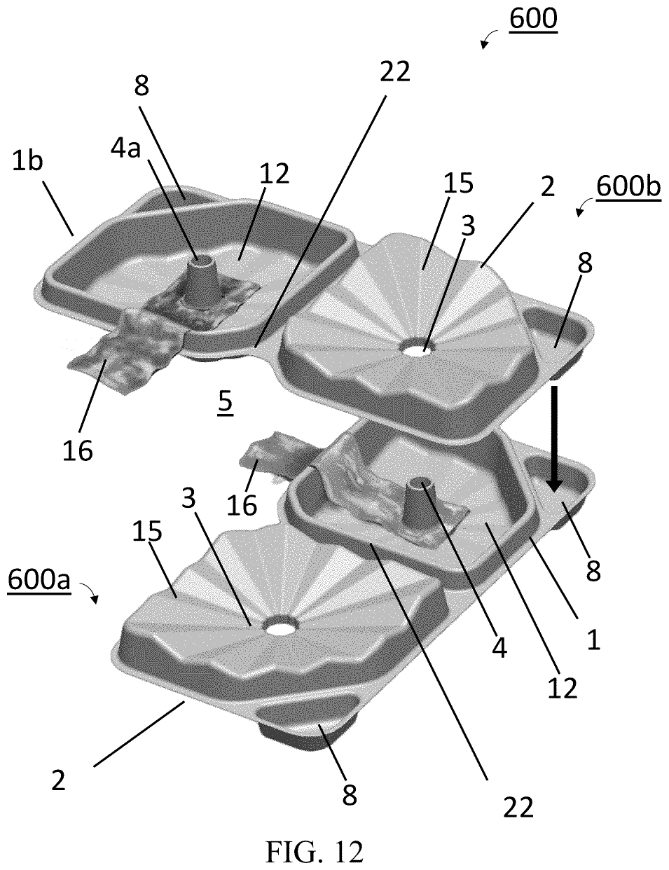

FIG. 12 shows a modular plant protecting apparatus 600 comprising a first apparatus 600a coupled to a second apparatus 600b. Each apparatus comprises a base 1 comprising a first rim, a water storage 12, and a plug-in-joint 4, a lid 2 coupled to the base comprising a second section and an opening 3, wherein the first rim is configured to correspondingly fit the second rim, wherein the opening is configured to correspondingly fit the plug-in-joint; and a recess 5 disposed on an edge of the base and on an edge of the lid. In particular, when coupling a first apparatus to a second apparatus, the first rim (base) of apparatus 600a correspondingly fits the second rim (lid) of apparatus 600b, the opening (lid) of apparatus 600b correspondingly fits the plug-in-joint (base) of apparatus 600a, and the recess is disposed on an edge of the linkage 22. As shown, each apparatus has a capillary fabric 16 that transports water from a water storage to a plant root. The main advantage of the modular apparatus is enabling easy transport to different terrains and easy expansion of protection as a plant grows over time. The structure creates a strong radial structure to withstand adverse environmental factors and maintain a stable connection with a ground. An infinite number of modular apparatuses may be coupled to expand plant growth protection.

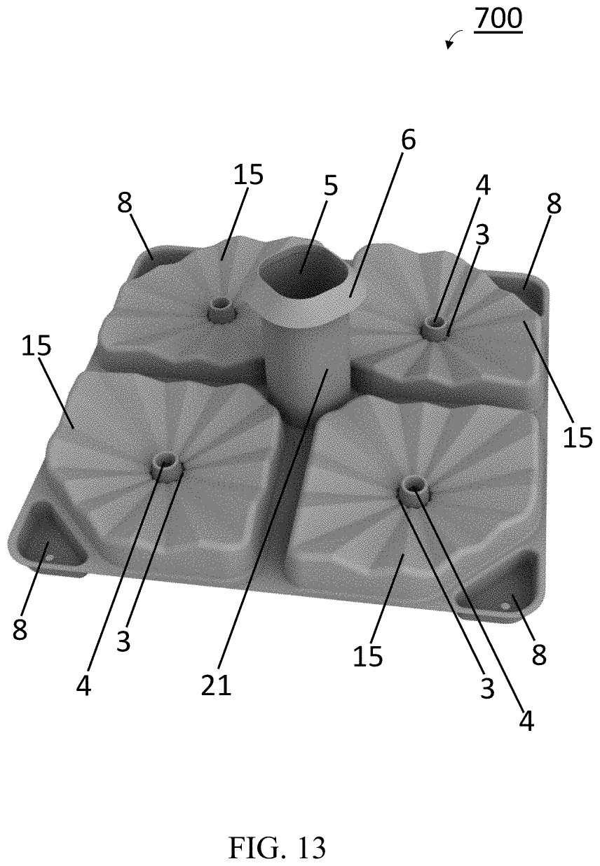

FIG. 13 shows a perspective view of a modular plant protecting apparatus 700 comprising four modular apparatuses with a guard 21.

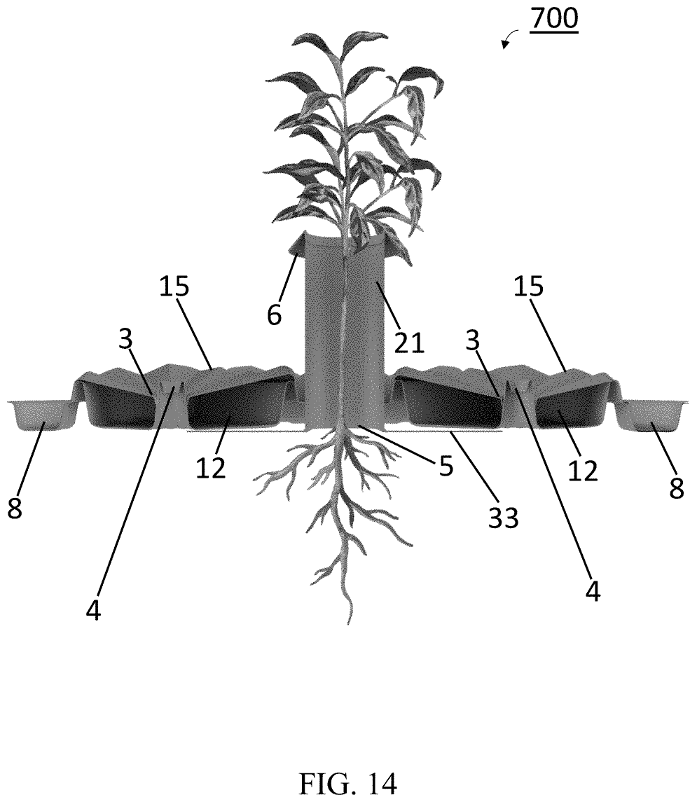

FIG. 14 shows a cross-sectional view of the modular plant protecting apparatus 700 with a plant in recess 5 protected by a guard 21. In this example, the guard forms a tubular structure having feet 33. Alternatively, the guard can be integrally formed with the base, the lid, or both.

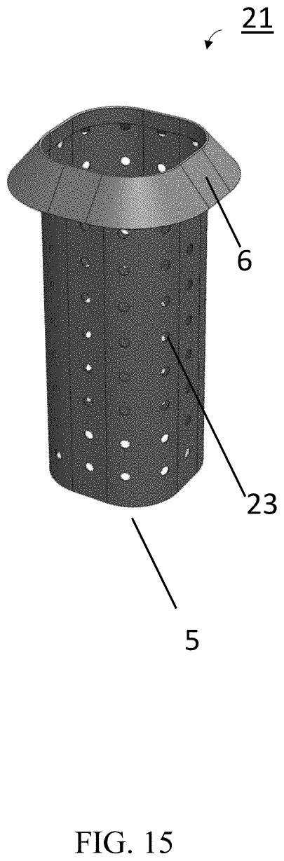

FIG. 15 shows a perspective view of the guard. As shown, the guard 21 comprises a body and holes 23 disposed on the body; and a negative shape 6 disposed on one end of the body. The body has a substantially square tubular form. In other examples, body comprises a cylindrical, pyramidal, geometric or another shaped form. The body comprises one or more units. The guard outlines the recess 5 to protect and provide shade for a plant. The holes 23 promote breathability, greater humidity, and fog condensation for a plant. The negative shape 6 provides a barrier against invasive species, specifically leafcutter ants.

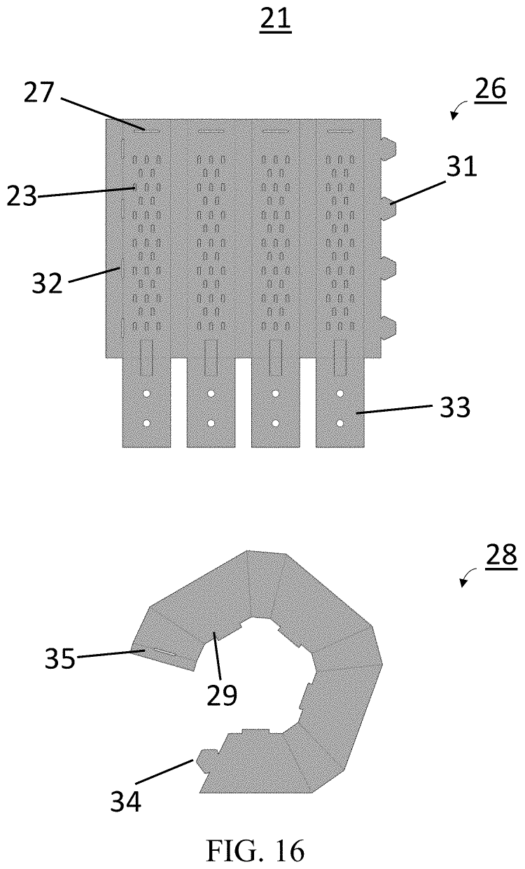

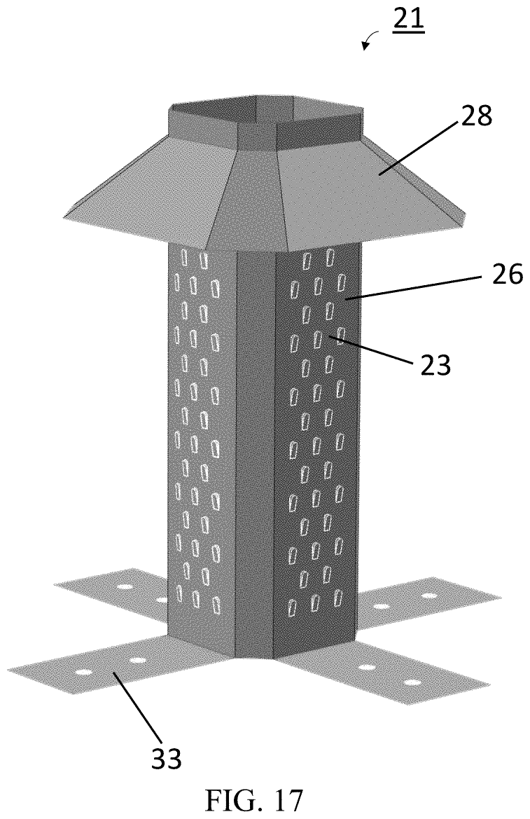

FIG. 16 and FIG. 17 show a guard according to other embodiments. As shown in FIG. 16, the guard comprises a body 26. The body is a flat piece of die-cut material that forms a three-dimensional structure by folding and inserting a tab 31 into a slot 32. The guard feet 33 stabilizes the guard on a ground surface. The holes 23 promote breathability, greater humidity, and fog condensation for a plant. The guard may include a shade 28. The shade 28 is a flat piece of die-cut material that forms a three-dimensional structure by folding and inserting a tab 34 into a slot 35. As seen in FIG. 17, the shade 28 can be attached to the body 26 by folding and inserting a tab 29 into a slot 27. The body may be used alone or in combination with other features as disclosed herein to protect plant growth.

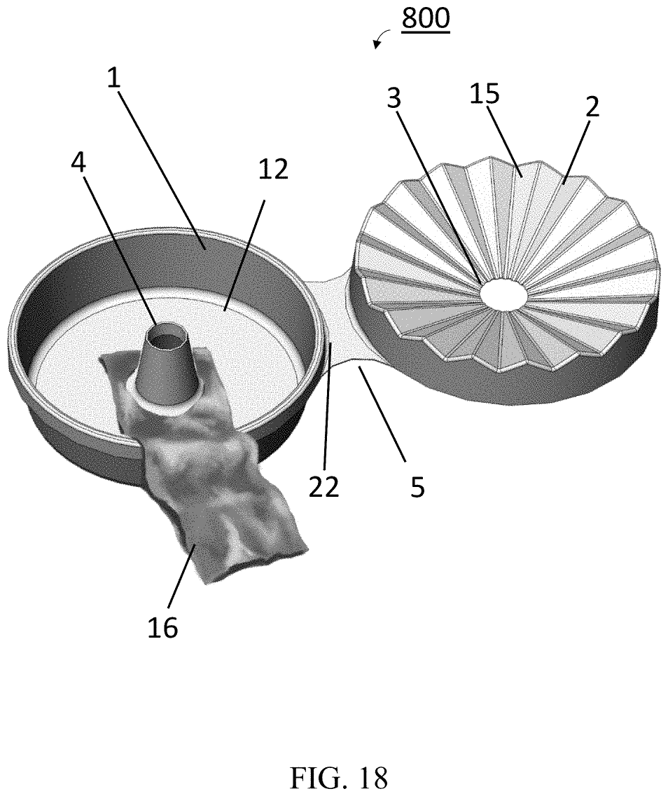

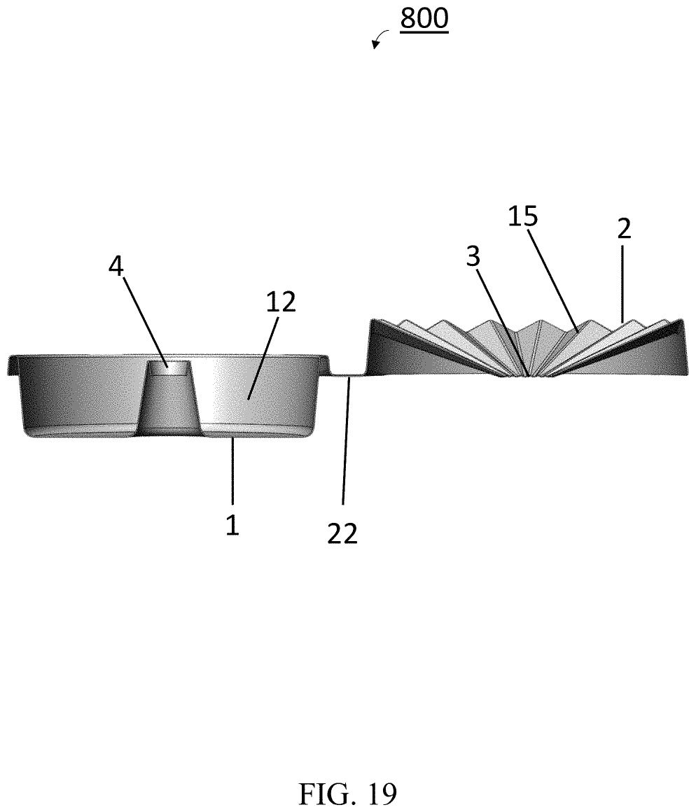

FIG. 18 shows a perspective view of a modular plant protecting apparatus 800. FIG. 19 illustrates a cross-sectional view of the modular apparatus. Similar to apparatus 500 (FIG. 10), the modular plant protecting apparatus 800 comprises a base 1 integrally connected with a lid 2 by a linkage 22. The base comprising a first rim, a water storage 12, and a plug-in-joint 4, a lid 2 coupled to the base comprising a second rim and an opening 3, wherein the first rim is configured to correspondingly fit the second rim, wherein the opening is configured to correspondingly fit the plug-in-joint; and a recess 5 disposed on an edge of the base and on an edge of the lid. The modular apparatus includes a circular structure. Additionally, the base, the lid, or both may include a filling space 8. The lid has a textured surface 15 with an opening 3 through which water enters a water storage of a base. A capillary fabric 16 disposed on the water storage and on the recess enables water transport from a water storage to a plant root.

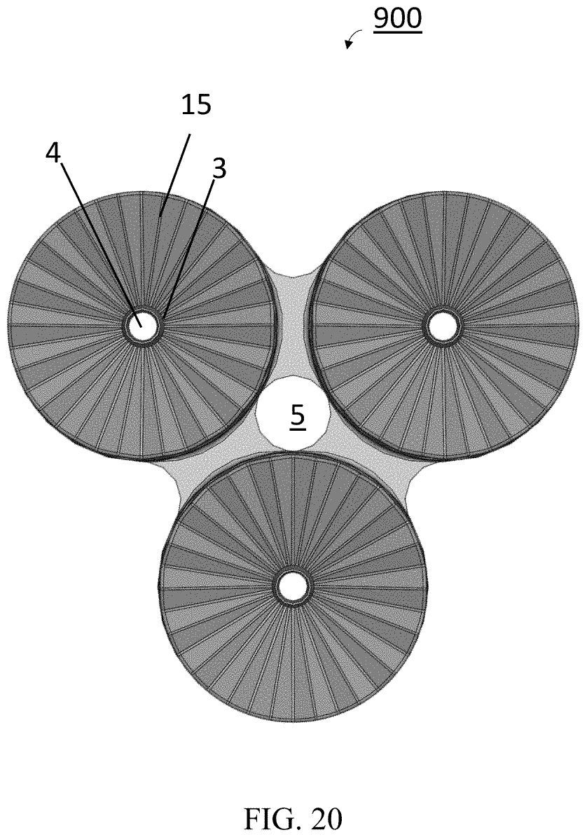

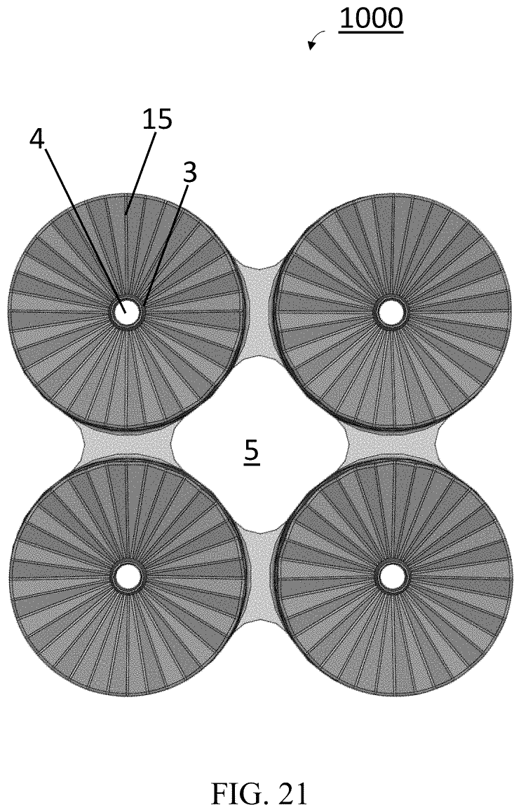

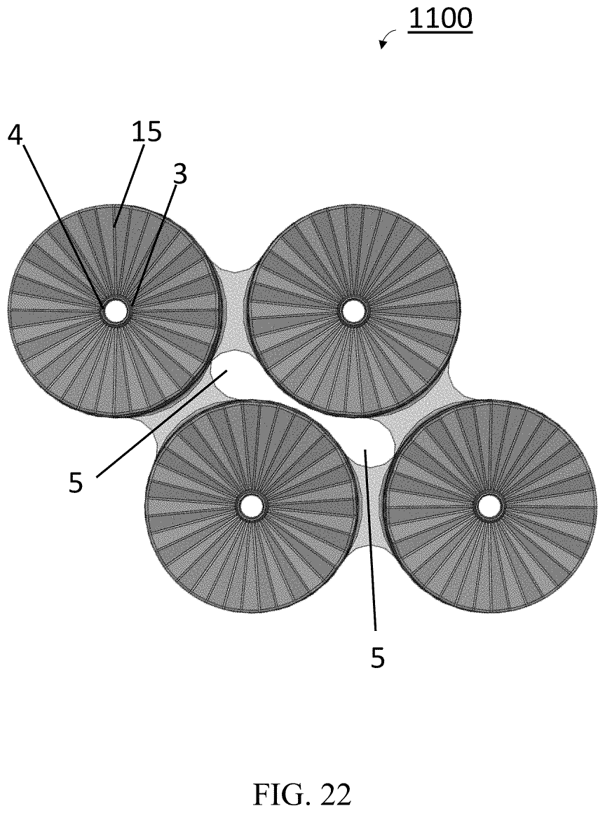

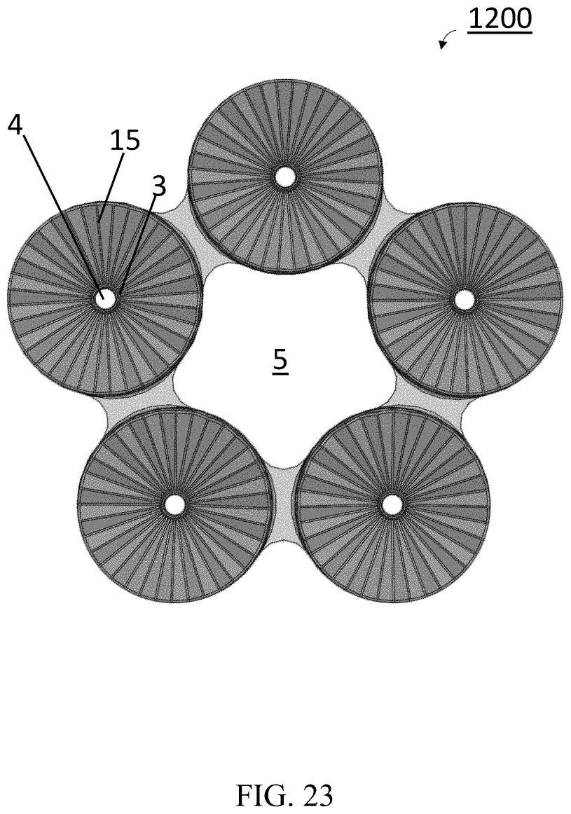

FIG. 20 shows a top view of a modular plant protecting apparatus 900 comprising three apparatuses. As a plant grows and more area is needed, modular apparatuses can be added to enlarge the recess 5. As shown in FIG. 21, a modular plant protecting apparatus 1000 comprising four apparatuses form an enlarged recess. Alternatively, FIG. 22 shows a modular plant protecting apparatus 1100 also comprising four apparatuses that form a different shaped recess. For example, this recess accommodates planting two seedlings in the area as indicated. FIG. 23 shows a modular plant protecting apparatus 1200 comprising five apparatuses. Advantages of the modular apparatus include enabling numerous configurations to accommodate natural plant growth patterns and various terrains. The modular apparatuses can conform to a terrain with a slope or a non-flat surface.

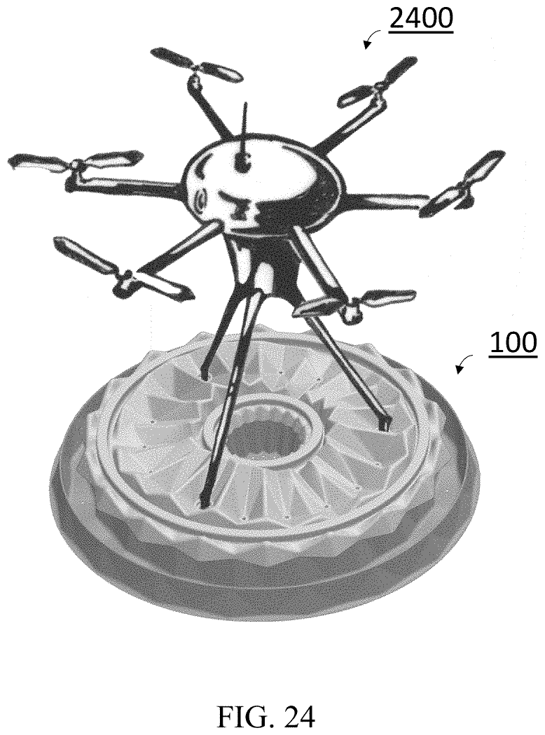

FIG. 24 shows a perspective view of the modular plant protecting apparatus 100 detachably coupled to an aerial vehicle 2400. The benefit of aerially deployment apparatuses is ease of transporting and distributing in planting areas that are difficult to access by foot or ground-based vehicles. In various cases, the aerial vehicle may include a drone, a remote-controlled airplane or a helicopter, a manned airplane or helicopter, a parachute, or a combination thereof. The deployment of the modular plant protecting apparatuses is not limited to methods involving aerial vehicles. Other deployment methods may include launching from slingshot or pressurized cannon or by other means apparent by one of ordinary skill.

The modular apparatus for plant protection affords many advantages. For example, the modular apparatus enables simple and cheap manufacturing which better fit manufacturing machines. Also, the ability to disassemble one or more modular apparatus enables efficient transplantation for protecting one or more plants in various terrains.

The modular plant protecting apparatus may be composed of materials including, but not limited to: plastics, acrylics, polyesters, polyurethanes, metals, slowly-degrading plastics, slowly-degrading ployvinylalcohol, natural fibers, aluminum, sugarcane bagasse, coconut fiber, sisal fiber, slowly-degrading paper-based materials, paper-based materials, or a combination thereof. Preferably, the modular plant protecting apparatus may be constructed of polypropylene with an oxo-biodegradable material. The modular plant protecting apparatus can be manufactured using thermoforming, vacuum-forming, stamping, injection molding, molded pulp, molded fiber, thermoformed fiber, die-cutting, molding, or combination thereof.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

1. A modular apparatus for protecting plant growth comprising:
a base comprising a first rim, a water storage, and a plug-in-joint,
a lid comprising a second rim and an opening,
wherein the first rim is configured to correspondingly fit the second rim,
wherein the opening is configured to correspondingly fit the plug-in-joint; and
a recess disposed on an edge of the base and on an edge of the lid.

2. The apparatus of claim 1, wherein the base is permanently or detachably coupled to the lid.

3. The apparatus of claim 1, further comprising a capillary fabric.

4. The apparatus of claim 1, wherein the lid further comprises a textured surface comprising a peak and a valley.

5. The apparatus of claim 4, wherein the lid further comprises an opening within a valley.

6. The apparatus of claim 1, wherein the base comprises a circular form.

7. The apparatus of claim 1, wherein the base comprises a rectangular form.

8. The apparatus of claim 1 wherein the lid comprises a circular form.

9. The apparatus of claim 1 wherein the lid comprises a rectangular form.

10. The apparatus of claim 1, further comprising a guard.

11. The apparatus of claim 1, further comprising a material including polypropylene, an oxo-biodegradable material, a bagasse fiber, a bagasse-based fiber, a plant fiber, a plant-based fiber, or a combination thereof.

12. The apparatus of claim 10, further comprising a material including polypropylene, an oxo-biodegradable material, a bagasse fiber, a bagasse-based fiber, a plant fiber, a plant-based fiber, or a combination thereof.

13. A modular apparatus for protecting plant growth comprising:
a base comprising a first inner rim, a first outer rim, a water storage, and a first plug-in-joint,
a lid comprising a second inner rim, a second outer rim, and a second plug-in-joint, wherein the first inner rim is configured to correspondingly fit the second inner rim, the first outer rim is configured to correspondingly fit the second outer rim, and the first plug-in-joint is configured to correspondingly fit the second plug-in-joint; and
a recess disposed on the base corresponding to a recess disposed on the lid.

14. The apparatus of claim 13, wherein the lid further comprises a dual-colored material, wherein an exterior surface comprises a light reflecting color and an interior surface comprises a light absorbing color.

15. The apparatus of claim 13, wherein the base is permanently or detachably coupled to the lid.

16. The apparatus of claim 13, further comprising a capillary fabric.

17. The apparatus of claim 13, wherein the lid further comprises a textured surface comprising a peak and a valley.

18. The apparatus of claim 17, wherein the lid further comprises an opening within a valley.

19. The apparatus of claim 13, further comprising a guard.

20. The apparatus of claim 13, further comprising a material including polypropylene, an oxo-biodegradable material, a bagasse fiber, a bagasse-based fiber, a plant fiber, a plant-based fiber, or a combination thereof.
